(19) United States
(12) Patent Application Publication
(10) Pub. No.: US 2007/0256885 A1
(43) Pub. Date: Nov. 8, 2007

(54) Steering System

(75) Inventors: Dieter Ammon, Remseck (DE); Ingo Dudeck, Weinstadt (DE); Axel Gern, Leutenbach (DE); Rainer Moebus, Stuttgart (DE); Volker Oltmann, Calw (DE); Reinhold Schoeb, Gaeufelden (DE); Bernd Woltermann, Fellbach (DE); Zoltan Zomotor, Stuttgart (DE)

Correspondence Address: Davidson, Davidson & Kappel, 485 Seventh Avenue, 14th Floor, New York, NY, 10018, US

(73) Assignee: DaimlerChrysler AG, Stuttgart (DE)

(21) Appl. No.: 11/587,394

(22) PCT Filed: Apr. 14, 2005
(86) PCT No.: PCT/EP05/03908

§ 371 Date: Mar. 14, 2007

(30) Foreign Application Priority Data
Apr. 14, 2004 (DE) 10 2004 017 987.5

(51) Int. Cl. B62D 5/06; B62D 5/04; B62D 6/00

(52) U.S. Cl. 180/417; 180/446; 701/42; 74/665 R

(57) ABSTRACT

A steering system (1) of a vehicle, having a steering wheel (2) which is connected mechanically to the steerable vehicle wheels (11) via a steering column (3). A superimposition actuator (26) which can be actuated independently of the driver by a control device (25) is provided for generating a superimposition variable (U). A superimposition device (6) superimposes a steering wheel variable (δ_{H}) which describes the steering actuation of the steering wheel (2) and the superimposition variable (U) to form an output variable. A steering actuator (19) sets a steering angle (δ_{L}) at the steerable vehicle wheels (20) as a function of the output variable. An actuating device (27) is provided which is actuated by the control device (25) in order to generate an actuating device torque (MS) which acts on the steering column. Here, the control device (25) at the same time actuates the superimposition actuator (26) and the actuating device (27), with the result that the steering angle (δ_{L}) and a reaction moment (MR) which results from the superimposition variable (U) and the actuating device torque (MS) and feeds back on the steering wheel (2) are influenced independently of the driver.

The invention relates to a steering system according to the preamble of patent claim 1.

In the steering system, the steering wheel of the vehicle is coupled mechanically to the steerable vehicle wheels.

An active front steering system having a superimposition device is apparent from DE 102 20 123 A1. The handle variable which is generated by the steering actuation of the steering handle and a superimposition variable which is generated by a superimposition actuator are superimposed by the superimposition device to form an output variable. In accordance with the output variable, the steering angle at the steerable vehicle wheels is set by a steering actuator.

During the actuation of the superimposition actuator, a reaction moment which can be felt by the driver is also always sent back to the steering handle by the superimposition device. An active steering intervention which is independent of the driver is only possible via the superimposition actuator if the driver supports the reaction moment. Reaction moments which occur unexpectedly can irritate the driver, in particular, at relatively high vehicle speeds.

It is an object of the present invention to provide a steering system which improves the possibilities for active steering interventions which are independent of the driver.

This object is achieved by the features of patent claim 1.

By way of the steering system according to the invention, it becomes possible to perform, for example, interventions in the driving dynamics. It is known, for example, to influence the steering system by driving dynamic systems, such as ESP systems, as an alternative or in addition to the actuation of the brakes, if the vehicle has an actual yaw rate which deviates from the setpoint yaw rate. Steering interventions of this type can take place with the steering system according to the invention, without reactions which are irritating for the driver taking place via the active steering intervention on the steering handle. For this purpose, the superimposition actuator and the actuating device are actuated at the same time. The steering angle at the steerable vehicle wheels is influenced via the superimposition actuator or the actuating device. The reaction moment on the steering wheel can be influenced by way of the respectively other actuator, that is to say by way of the actuating device or the superimposition actuator, as a result of which reaction moments can be avoided which are disruptive or irritate the driver.

Without the actuating device which is provided in addition to the superimposition actuator, the reaction moment could not be influenced by a steering intervention on the steering wheel which is independent of the driver. No desired steering intervention which is independent of the driver could take place, as the driver would have to completely support the reaction moment which occurs. The driver is therefore assisted during steering of his vehicle by the additional steering moment which can be set by means of the actuating device independently of the steering system, and is not irritated or unsettled by unexpected reaction moments as a consequence of an additional steering angle which is set independently of the driver.

Moreover, the comfort can be increased by the steering system according to the invention. For example, disruptive variables can be suppressed in a targeted manner. The straight line stability of the vehicle can be improved and disruptive moments which are transmitted by the wheels to the steering wheel, for example, on account of unevennesses of the roadway can be reduced.

Furthermore, as has already been mentioned, driving dynamic steering interventions are made possible, for example in order to regulate the yaw rate, there being no restrictions for the steering angle influencing which is independent of the driver on account of the reaction moments which can be influenced. The functionality of the present steering system comes very close to a concept of what is known as a steer by wire steering system, although there is a mechanical connection here between the steering handle and the steered wheels. Further possible applications of the steering system according to the invention result, for example, in steering interventions which are independent of the driver in the context of a lane discipline assistance system or a parking assistance system.

Advantageous refinements of the steering system result from the dependent patent claims.

It is advantageous if a setpoint reaction moment is predefined in a fixed manner or a manner which is dependent on parameters, and the reaction moment is set in accordance with the setpoint reaction moment. As a result of this measure, desired reaction moments to the haptic driver information or the current driving situation of the vehicle can be set, without there being the risk of an irritation of the driver. The setpoint reaction moment can also be approximately equal to zero here, it then not being possible to sense a reaction at the steering wheel.

In one refinement which is simple to realize, the actuating device acts on the first steering column section which connects the steering wheel and the superimposition device.

As an alternative to this, it is also possible for the actuating device to act on the second steering column section which connects the superimposition device and a steering actuator which is provided at the steerable vehicle wheels in order to set the steering angle. The actuating device torque which is transmitted back from the actuating device to the steering wheel is then also changed by the transmission ratio of the superimposition device. As an alternative to acting on the second steering column section, in order to achieve a compact construction, the actuating device can act on a steering actuator which is provided at the steerable vehicle wheels in order to set the steering angle, for example directly on the rack of a steering system which is configured as a rack and pinion steering system.

Furthermore, it is advantageous if the steering system is configured as an electric, hydraulic or electrohydraulic power steering system. Here, the actuating device can be a constituent part of the power assistance device, with the result that components of the power steering system which are already present in any case are used as actuating device at the same time. As a result, the component complexity and cost can be reduced.

If the superimposition device and/or the power assistance device are integrated in the steering actuator as a common structural unit, a very compact design can be achieved.

The actuating device can be configured such that it can be activated fluidically or electrically.

Fluidic activation which is simple to implement can be brought about by a pressure difference between a first pressure potential and a second pressure potential, the magnitude of the actuating device torque depending on the magnitude of the pressure difference and the direction of the actuating device torque depending on the preceding sign of the pressure difference. Here, in particular, hydraulic activation of the actuating device can be provided when it is a hydraulic or electrohydraulic power steering system.

In one particularly expedient embodiment, the actuating device is used at the same time for centering the steering system and the steering handle. The steering system and the steering handle are centered in conjunction with the actuating device which can be activated fluidically, when the same pressure prevails between the two pressure potentials.

Exemplary embodiments of the invention will be explained in greater detail using the appended drawing, in which:

FIG. 1 shows a diagrammatic illustration of a first exemplary embodiment of a steering system which is embodied as a hydraulic power steering system with a superimposition device,

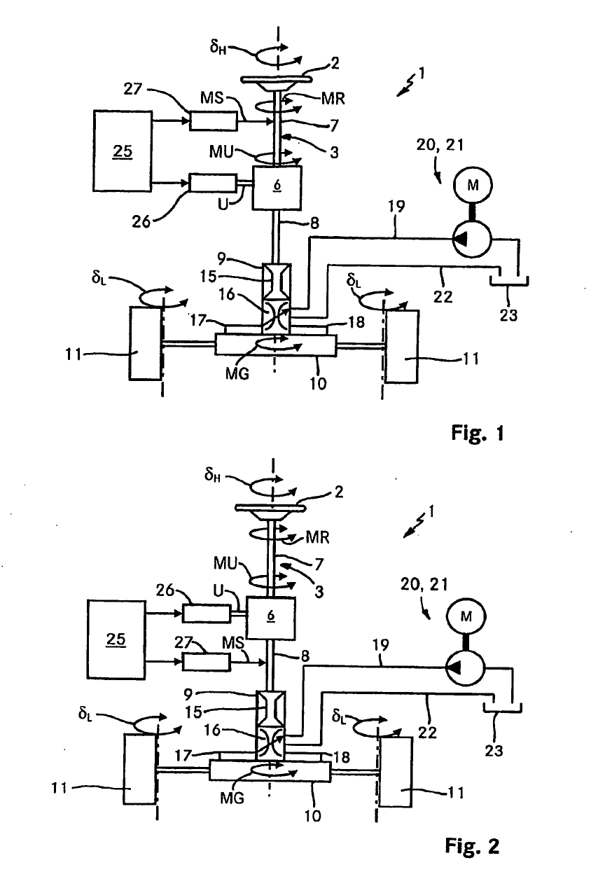

FIG. 2 shows a diagrammatic illustration of a second exemplary embodiment of a steering system which is embodied as a hydraulic power steering system with a superimposition device,

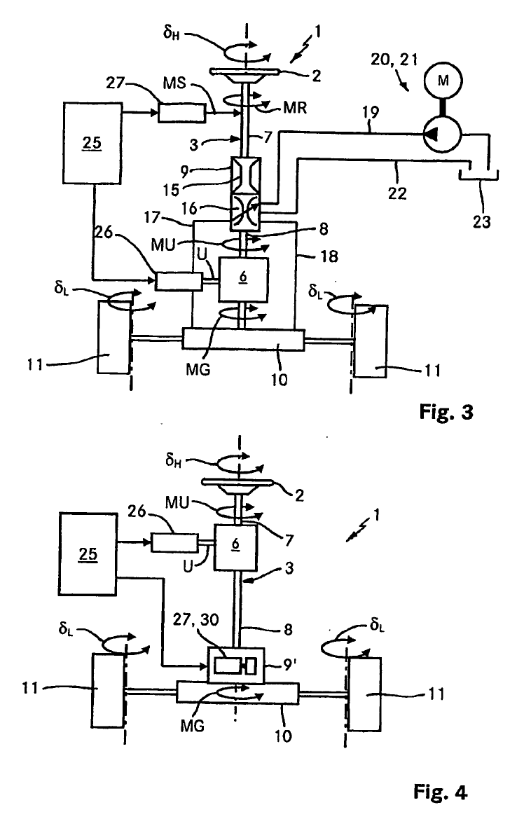

FIG. 3 shows a diagrammatic illustration of a third exemplary embodiment of a steering system which is embodied as a hydraulic power steering system with a superimposition device,

FIG. 4 shows a diagrammatic illustration of a fourth exemplary embodiment of a steering system which is embodied as an electric power steering system with a superimposition device, and

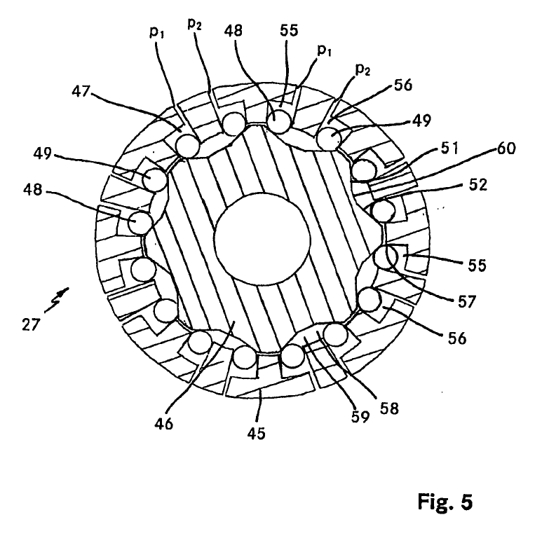

FIG. 5 shows a diagrammatic illustration in cross section of one exemplary embodiment of an actuating device of a steering system.

FIG. 1 shows a steering system 1 which has a steering wheel 2 which is connected via a steering column 3 to a steering actuator 10 which is provided in order to set the steering angle δ_{L} at the steerable vehicle wheels 11. Furthermore, the steering system 1 has a superimposition device 6 which is connected to the steering wheel 2 via a first section 7 of the steering column 3. The superimposition device 6 is connected to a steering actuator 10 via a second section 8 and a power assistance device 9 which is hydraulic according to the invention.

In all the exemplary embodiments which are shown here, the superimposition device 6 is realized as a variable ratio gear unit, for example as a planetary gear mechanism or what is known as a harmonic drive gear mechanism.

The hydraulic power assistance device 9 has a setting element 15 which sets the valve opening of a steering valve 16 of the power assistance device 9 as a function of an actuating variable. A first actuating line 17 and a second cutoff line 18 connect the steering valve 16 to the steering actuator 10. The steering valve 16 is connected via a feed line 19 to a pressure source 20, for example to the pressure side of a motor/pump unit 21. A return line 22 connects the steering valve 16 to a reservoir 23. In the exemplary embodiment which is described here, the setting element 15 is formed by a torsion bar 24 which detects the actuating angle or the actuating moment which prevails at the second section 8 of the steering column 3 as an actuating variable. The valve opening of the steering valve 16 is varied as a function of the direction and the magnitude of the actuating variable. As a result, an auxiliary force for actuating the steering actuator 10 is produced in accordance with the actuating variable.

The superimposition device 6 is connected to a superimposition actuator 26 which can be actuated by a control device 25. The superimposition actuator 26 can be formed by an electric motor and generates a superimposition variable U which is formed according to the example by a superimposition angle and is transmitted mechanically to the superimposition device 6.

The control device 25 also actuates an actuating device 27 which can likewise be formed by an electric motor and which serves to influence the reaction moment MR which can be sensed by the driver at the steering wheel 2. For this purpose, an actuating device torque MS or resistance moment can be generated via the actuating device 27, which actuating device torque MS or resistance moment acts on the first section 7 of the steering column 3 in the exemplary embodiment of the steering system 1 which is shown in FIG. 1.

The control device 25 determines which superimposition variable U and which actuating device torque MS are to be set on the basis of one or more input signals such as the steering handle angle δ_{H}, the steering moment, the lane course, the tire forces, the vehicle longitudinal speed, the actual yaw rate, the attitude angle, etc. As a result, a reaction moment MR which is desired at the steering wheel 2 can be achieved. Input signals of this type, in particular input signals which describe the current longitudinal and/or transverse dynamic state of the vehicle, can either be detected in the vehicle directly by sensor means or can be determined indirectly from sensor variables. Many input variables of this type are already available in modern vehicles on a vehicle data bus.

As an alternative, there can be a superordinate driving system regulator (not shown) which determines the superimposition variable U and transmits it to the control unit 25, with the result that the control unit 25 defines only the actuating device torque MS. Here, the driving system regulator is provided, for example, in order to regulate the straight line stability of the vehicle and/or to compensate for transverse dynamic disruptive variables such as side wind or transverse inclinations of the roadway and/or to regulate the actual yaw angle of the vehicle in accordance with the current steering wheel angle and/or to carry out a lane discipline operation which is independent of the driver. Here, one or more of the abovementioned input variables are supplied to the driving system regulator.

In the case of a steering intervention which is independent of the driver, a reaction moment MR is caused which feeds back to the steering wheel and results in the present invention from a superimposition moment MU which is caused by the superimposition actuator and the actuating device torque MS.

As a result of the additional degree of freedom which is afforded by the provision of the actuating device, there is the possibility to fix the steering column by the actuating device torque, to perform a steering intervention or to set the reaction moment MR according to a predefinable setpoint reaction moment. Here, the magnitude of the setpoint reaction moment can also not equal zero, in order to give the driver a desired haptic feedback via the steering intervention which is independent of the driver. If the magnitude of the setpoint reaction moment is selected to be approximately equal to zero, the actuating device torque MS has to be selected in such a way that the superimposition moment MU is compensated for. In the case of an actuating device 27 which acts on the first section 7 of the steering column 3 between the superimposition device 6 which is formed by the variable ratio gear unit and the steering wheel 2, the actuating device torque then corresponds to the negative superimposition moment MU: MS=−MU.

As an alternative to the possibility of predefining the setpoint reaction moment in a fixed manner, it is also possible to predefine the setpoint reaction moment in a manner which is dependent on parameters, by a characteristic curve and/or a characteristic diagram and/or a computer model. One or more of the following variables or variables which are correlated therewith can be used as parameters: vehicle longitudinal speed, vehicle longitudinal acceleration, vehicle transverse acceleration, yaw rate, wheel rotational speeds, steering wheel angle, steering wheel angular speed, angular speed at the output of the superimposition device 6 or of the second section 8 of the steering column 3, angular speed of the pinion which acts on the steering actuator 10, the auxiliary force at the steering actuator 10 which is made available via the power assistance device 9, the hydraulic pressures which prevail in the actuating line 17, 18 or in the steering actuator in the case of a hydraulic power assistance device 9, the steering moment at the steerable vehicle wheels 11, the motor current of the superimposition actuator 26 which is configured as an electric motor or the actuating device 27 which is configured as an electric motor, the actuating device torque MS, the superimposition moment MU which is provided by the superimposition actuator 26, and wheel braking moments at one or more of the vehicle wheels.

Here, the characteristic curve, the characteristic diagram or the computer model can also be updated during driving operation.

The superimposition moment MU can be calculated from the difference between the overall steering moment MG which currently prevails during the actuating activation of the superimposition actuator 26 at the input of the steering actuator 10 and a basic steering moment MO when the superimposition actuator 26 is not actuated:
MU=MG−MO (1)

Here, the overall steering moment MG can be detected directly by sensor means or can be calculated from the motor current I of the superimposition actuator 26, the following equation being valid for the first exemplary embodiment according to FIG. 1:
MG=I·i·k (2)
where:
MG: overall steering moment at the input of the steering actuator 10
I: motor current of the superimposition actuator 26
i: transmission ratio of the superimposition device 6
k: motor constant of the superimposition actuator 26

The basic steering moment MO when the superimposition actuator 26 is not actuated can be determined from a characteristic diagram and/or a computer model, the basic steering moment MO depending on one or more of the following parameters: tire forces, transverse acceleration, steering wheel angle, steering wheel angular speed and vehicle longitudinal speed or a variable which is correlated with one of the abovementioned parameters.

As long as the steering wheel input variable on the superimposition device 6, which is therefore the steering wheel angle δ_{H} in FIG. 1, does not change (δ_{H}=constant), the superimposition moment MU when the superimposition actuator is actuated can be determined as follows:
MU=MG(tn)−MO(t0) (3)

where:

instants t0<tn, n=1, 2, 3, . . . and

MO(t0)=0.

FIG. 2 shows a further embodiment of the steering system 1, the actuating device 27 not acting on the first section 7 of the steering column 3 as in FIG. 1, but on the second section 8 of the steering column 3 between the superimposition device 6 and the power assistance device 9. Otherwise, the steering system according to FIG. 2 corresponds to the first exemplary embodiment which is shown in FIG. 1.

If the actuating device 27 acts on the second section 8 of the steering column 3 which is connected to the vehicle wheel output of the superimposition device 6, the following relationship is valid instead of equation (2):
MG=I·i·k+MS (4)
where:
MG: overall steering moment at the input of the steering actuator 10
I: motor current of the superimposition actuator 26
i: transmission ratio of the superimposition device 6
k: motor constant of the superimposition actuator
MS: actuating device torque

FIG. 3 shows a third embodiment of the steering system 1. In contrast to the first exemplary embodiment according to FIG. 1, the power assistance device 9 is arranged in the first section 7 of the steering column 3, with the result that the second section 8 of the steering column 3 connects the output of the superimposition device 6 directly to the input of the steering actuator 10. The actuating device 27 acts on the first section 7 of the steering column 3 between the steering wheel 2 and the power assistance device 9, in order to generate an actuating device torque MS which acts on the steering wheel 2. In a modification from this, it would also be possible for the actuating device to act on the first section 7 of the steering column 3 between the power assistance device 9 and the superimposition device 6. In this third embodiment, the input of the superimposition device 6 can be connected directly to the steering valve 16 of the power assistance device 9, and the output can be connected directly to the steering actuator 10, as a result of which a structural unit is formed, which leads to a particularly compact overall size. In this third embodiment (FIG. 3), the method of operation corresponds to that of the first exemplary embodiment according to FIG. 1.

In a modification from the first three exemplary embodiments, FIG. 4 shows a fourth exemplary embodiment of the steering system 1 which is configured as an electric power steering system. Here, an electric power assistance device 9′ which has an electric power assistance motor 30 is provided instead of the hydraulic power assistance device 9. Here, the electric power assistance motor 30 is also used as an actuating device 27, with the result that an additional electric motor for the actuating device 27 can be omitted. It is possible here for the electric power assistance motor 30 which serves as an actuating device 27 to act directly on a rack (not shown) of the steering actuator 10. As has already been explained in conjunction with the second exemplary embodiment, equation (4) is valid for this fourth embodiment instead of equation (2), as the actuating device 27 acts on the second section 8 of the steering column 3 or on the rack of the steering actuator 10 and therefore on a steering part which is connected to the output of the superimposition device 6.

In a modification from the four exemplary embodiments which are shown, it is also possible to provide a steering system 1 with a plurality of actuating devices 27 which act at various locations, in particular, on a steering part which is connected mechanically to the steering wheel input of the superimposition device 6 and on a steering part which is connected mechanically to the output of the superimposition device 6. This results in combinations of the exemplary embodiments which have been described in the preceding text.

In one modified design variant of the first three exemplary embodiments, the actuating device 27 can also be a constituent part of the power assistance device 9, with the result that the installation space requirement can be reduced. Here, the actuating device 27 is configured as a hydraulically actuated actuating device. FIG. 5 shows one possible embodiment of a hydraulic actuating device 27.

The hydraulic actuating device 27 according to FIG. 5 is based on a modified reaction arrangement of a power assistance device 9. A reaction arrangement of this type serves to center the hydraulic power steering system and is described, for example, in DE 196 16 439 C1, to which reference is expressly made to this extent.

A rotary slide 46 of tubular configuration is surrounded coaxially by a control sleeve 45 in the region of an axial section, it being possible for the rotary slide 46 and the control sleeve 45 to be rotated relative to one another in the radial direction. A differential pressure is generated at two pressure connections of the control sleeve 45 as a function of the magnitude and direction of the relative rotation. An apparatus of this type is known in power steering systems.

For explanatory reasons, FIG. 5 shows the actuating device 27 in a cross section through the control sleeve 45 and the rotary slide 46. The control sleeve 45 and the rotary slide 46 delimit a plurality of axial recesses 47 which are distributed uniformly next to one another in the circumferential direction. Each of the axial recesses 47 has a first recess region 55 with a first pressure connection p₁ and a second recess region 56 with a second pressure connection p₂. In each case one ball 48 and 49 which is arranged between the control sleeve 45 and the rotary slide 46 is arranged in both recess regions 55, 56 of an axial recess 47. In the state of rest, the respective ball 48, 49 bears here against the associated recess region opening 57 in such a way that it closes the latter in a fluidically tight manner.

The two recess regions 55, 56 of an axial recess 47 can be connected fluidically to one another via an inner region 58. The inner region 58 is formed by a groove-like depression 59 in that outer face of the rotary slide 46 which faces the control sleeve 45. As viewed in cross section, the depression 59 has an approximately trapezoidal contour with two inclined flanks 51, 52, the two flanks 51, 52 being connected to one another via a connecting face 60 which extends substantially radially and forms the groove base of the groove-like depression 59. As viewed in the axial direction of the steering column 3, the flanks 51, 52 extend in an inclined manner, with the result that the flanks 51, 52 have a ramp-like profile, as viewed in the axial direction of the steering column 3. The two balls 48, 49 which are provided in the axial recess 47 rest in each case on one of the flanks 51 and 52, respectively.

The respectively assigned recess region 55 or 56 can be loaded with a hydraulic or pneumatic pressure via the pressure connections p₁ and p₂, respectively, as a result of which the assigned balls 48 and 49, respectively, are pressed against the flanks 51, 52 of the rotary slide 46. The rotary slide 46 is centered with respect to the control sleeve 45 in the event of identical pressures p₁, p₂. If the pressure at the first pressure connection p₁ is greater than the pressure at the pressure connection p₂, the rotary slide 46 is rotated relative to the control sleeve 45 in the counterclockwise direction. In the opposite case, a higher pressure at the second pressure connection p₂ than at the first pressure connection p₁ would lead to a relative rotation of the rotary slide 46 with respect to the control sleeve 45 in the clockwise direction.

The actuating device torque MS can therefore be produced by controlling the pressure difference between the pressure connections p₁ and p₂. It is also possible as a result of this relative rotation which is produced between the rotary slide 46 and the control sleeve 45 to set a handle angle δ_{H} or a steering angle δ_{L}.

The actuating device 27 is used at the same time for fixing or centering the steering system 1 and/or the steering handle 2. This fixing and/or centering takes place when the same pressure prevails between the two pressure potentials p₁, p₂.

1: A steering system of a vehicle, having a steering wheel which is connected mechanically to the steerable vehicle wheels via a steering column, having a superimposition actuator which can be actuated independently of the driver by a control device for generating a superimposition variable, having a superimposition device which superimposes a steering wheel variable which describes the steering actuation of the steering wheel and the superimposition variable to form an output variable, and having a steering actuators for setting a steering angle at the steerable vehicle wheels as a function of the output variable, characterized in that an actuating device is provided which is actuated by the control device in order to generate an actuating device torque which acts on the steering column, and in that the control device at the same time actuates the superimposition actuator and the actuating device, with the result that the steering angle and a reaction moment which results from the superimposition variable and the actuating device torque and feeds back on the steering wheel are influenced independently of the driver.

2: The steering system as claimed in claim 1, characterized in that a setpoint reaction moment is predefined in a fixed manner or a manner which is dependent on parameters, and the reaction moment is set in accordance with the setpoint reaction moment.

3: The steering system as claimed in claim 2, characterized in that the setpoint reaction moment is substantially zero.

4: The steering system as claimed in claim 1, characterized in that the actuating device acts on the first steering column section which connects the steering wheel and the superimposition device.

5: The steering system as claimed in claim 1, characterized in that the actuating device acts on the second steering column section which connects the superimposition device and the steering actuator which is provided at the steerable vehicle wheels in order to set the steering angle.

6: The steering system as claimed in claim 1, characterized in that the actuating device acts on a steering actuator which is provided at the steerable vehicle wheels in order to set the steering angle, in particular on a rack of a rack steering actuator.

7: The steering system as claimed in claim 1, characterized in that the superimposition device and the steering actuator are integrated in a common structural unit.

8: The steering system as claimed in claim 1, characterized in that the steering system is configured as a power steering system, having a power assistance device which generates an auxiliary force in order to assist the driver in a steering actuation of the steering handle.

9: The steering system as claimed in claim 8, characterized in that the superimposition device and the steering actuator and the power assistance device are integrated in one structural unit.

10: The steering system as claimed in claim 8, characterized in that the actuating device is a constituent part of the power assistance device.

11: The steering system as claimed in claim 10, characterized in that the actuating device has an electric motor.

12: The steering system as claimed in claim 1, characterized in that the actuating device is configured such that it can be actuated by fluid.

13: The steering system as claimed in claim 12, characterized in that the actuating device has a hydraulic motor or a pneumatic motor.

14: The steering system as claimed in claim 12, characterized in that the fluidic, in particular hydraulic actuation of the actuating device is brought about by a pressure difference between a first pressure potential and a second pressure potential, the magnitude of the actuating device torque depending on the magnitude of the pressure difference and the direction depending on the preceding sign of the pressure difference.

15: The steering system as claimed in claim 14, characterized in that the pressure difference brings about a relative rotation between a first steering column part, in particular a control sleeve, relative to a second steering column part, in particular a rotary slide.

16: The steering system as claimed in claim 12, characterized in that a first steering column part, in particular a control sleeve, encloses a second steering column part, in particular a rotary slide, coaxially in the circumferential direction, axial recesses having in each case two flanks which extend obliquely in the manner of a ramp as viewed in the axial direction of the steering column parts being provided between the two steering column parts which are arranged such that they can be rotated relative to one another, each flank being assigned a ball which is provided in the axial recess and rolls on the respectively assigned flank as a function of the pressure at the associated pressure potential or the pressure difference between the pressure potentials, as a result of which the relative rotation of the two steering column parts is brought about, with the result that a handle angle and/or a steering angle can be set.

17: The steering system as claimed in of claim 1, characterized in that the actuating device is used at the same time for fixing and, in particular, centering the steering system and the steering handle.

18: The steering system as claimed in claim 14, characterized in that, when the same pressure prevails between the two pressure potentials, the steering system and the steering handle are fixed and, in particular, centered.
